(19) United States
(12) Patent Application Publication
(10) Pub. No.: US 2025/0084791 A1
(43) Pub. Date: Mar. 13, 2025

(54) SYSTEM AND METHOD FOR CONDITIONING FUEL FOR AN AIR-BREATHING HYDROGEN ENGINE

(71) Applicants: ARIANEGROUP SAS, Les Mureaux (FR); AIRBUS OPERATION SAS, Toulouse (FR); SAFRAN SA, Paris (FR)

(72) Inventors: Louis Vianney MABILLE DE LA PAUMELIERE, Vernon Cedex (FR); Nicolas GUEZENNEC, Vernon Cedex (FR); Carlos Alberto CRUZ, Vernon Cedex (FR); Mathieu BELLEVILLE, Toulouse (FR); Samer MAALOUF, Massy (FR)

(73) Assignees: ARIANEGROUP SAS, Les Mureaux (FR); AIRBUS OPERATION SAS, Toulouse (FR); SAFRAN SA, Paris (FR)

(21) Appl. No.: 18/723,221

(22) PCT Filed: Dec. 21, 2022
(86) PCT No.: PCT/FR2022/052456

§ 371 Date: Jun. 21, 2024

(30) Foreign Application Priority Data
Dec. 23, 2021 (FR) FR2114405

(51) Int. Cl. F02C 7/22; F23R 3/28

(52) U.S. Cl. CPC F02C 7/22; F23R 3/28

(57) ABSTRACT

A fuel conditioning system for an aerobic hydrogen engine, including: at least one hydrogen pump configured to increase the pressure of the liquid hydrogen delivered at the outlet of a tank, one or several heat exchangers configured to increase the temperature of the pressurized hydrogen, an air supply circuit, at least one combustion device configured to ensure a partial combustion of the hydrogen with air coming from the air supply circuit in order to produce a fuel including a gas mixture including gaseous hydrogen and devoid of oxygen.

### TECHNICAL FIELD

The present disclosure relates to a fuel conditioning system and method for an aerobic hydrogen engine, in particular for an aircraft.

### PRIOR ART

Today, aircraft engine architectures are perfectly adapted to ingest kerosene, which is the common fuel of the aircrafts. These engines, in the family of which there are the turbojet engines and sometimes the turboprops, are called aerobic engines because they use oxygen from the air to carry out the chemical reactions necessary for the thrust. These aerobic engines can only be used in the atmosphere, unlike the engines called anaerobic engines of the launchers and spacecrafts which are capable of producing a thrust outside of any atmosphere. These latter can in particular use liquid hydrogen as fuel combined with liquid oxygen used as oxidizer to ensure the thrust performances necessary for this type of application in an oxygen-free environment.

Hydrogen aircraft engines exist but however do not allow accommodating liquid hydrogen in the combustion chamber of these engines due to its cryogenic nature, namely a particularly low temperature of the order of 20 to 30K.

One of the issues in designing a hydrogen supply system for an aircraft engine concerns the transformation of liquid hydrogen at very low temperature, of the order of 20 to 30K, and at low-pressure of the order of 1 bar, into hydrogen at high temperature (300K) and high-pressure (several tens of bars). These high temperature and high-pressure conditions are required for the injection of hydrogen into the combustion chamber of the aircraft engine in order to meet the performance, energy balance and operational safety requirements of such an aeronautical system.

Moreover, for a commercial aircraft, in particular of the short, medium or long-haul type, an additional issue lies in the fact that setting the temperature of the hydrogen in the conditions required at the inlet of the combustion chamber of the aircraft engine is independent of the heat sources derived from the aircraft engine, in particular those generated by the combustion gases of the chamber or the nozzle. Indeed, the use of these heat sources:
may lead to a reduction in the performances of the propulsion system of the aircraft,
generally does not offer sufficient amplitude in the fuel flow rate and pressure to manage all the flight phases while meeting the performance and consumption requirements required for this type of aircraft,
and can create a risk for the operational safety due to a risk of uncontrolled combustion of hydrogen in the vicinity of pressurized air which is present in the combustion chamber of the aircraft engine.

In view of the above, it would therefore be useful to design a hydrogen supply system for an aircraft engine which addresses at least one of the issues referred to above.

### Disclosure of the Invention

One embodiment relates to a fuel conditioning system for an aerobic hydrogen engine, characterized in that the system comprises:
at least one hydrogen pump configured to increase the liquid hydrogen pressure coming from a tank,
one or several heat exchanger(s) configured to increase the temperature of the pressurized hydrogen,
an air supply circuit,
at least one combustion device configured to ensure a partial combustion of the hydrogen with air coming from the air supply circuit in order to produce a fuel comprising a gas mixture including gaseous hydrogen and which is devoid of oxygen.

This conditioning system is designed autonomously from the combustion chamber of an aerobic hydrogen engine, that is to say it does not use the capacities available in the combustion chamber of the engine and, particularly, this system does not involve the hot gases derived from the combustion chamber of the engine to raise the temperature of the hydrogen. Moreover, this system makes it possible to efficiently transform liquid hydrogen at very low temperature, of the order of 20 to 30K, and at low-pressure of the order of 1 bar, into hydrogen at high temperature and high-pressure (e.g.: 550K and 40 bars) at the inlet of the combustion chamber of the aerobic engine. Furthermore, this system does not require an intermediate heat transfer fluid (e.g. helium) to isolate or seal the hydrogen from the air in order to prevent the risk of fire. On the contrary, the system provides for achieving a partial combustion of the hydrogen by consuming all the oxygen available at the time of combustion so that the gas mixture produced by the partial combustion no longer includes oxygen, thus eliminating any risk of fire or even explosion and therefore offering great operational safety.

According to other possible features:
said at least one hydrogen pump is disposed upstream of the heat exchanger(s) in the direction of circulation of the hydrogen from said at least one hydrogen pump;
the heat exchanger(s) is/are configured to increase the hydrogen temperature at least partly by cooling one or several fluid(s);
the system comprises a hydrogen circuit downstream of said at least one hydrogen pump in the direction of circulation of the hydrogen from said at least one hydrogen pump and a fuel circuit downstream of said at least one combustion device, the heat exchanger(s) being fluidly connected between the two circuits in order to increase the temperature of the hydrogen in the hydrogen circuit from the heat of the fuel produced by said at least one combustion device in the fuel circuit; thus, the heat resulting from this combustion mainly contributes to the increase in the temperature of the hydrogen;
the system comprises, downstream of said at least one hydrogen pump in the direction of circulation of the hydrogen from said at least one hydrogen pump, a turbine configured to ensure partial expansion of the pressurized hydrogen in order to provide to said at least one hydrogen pump, in mechanical form via a transmission shaft connecting the turbine to said at least one hydrogen pump, at least part of the power necessary for the operation of said at least one hydrogen pump;
the system comprises, downstream of said at least one combustion device in the direction of circulation of the fuel from said at least one combustion device, a turbine configured to ensure partial expansion of the fuel produced by said at least one combustion device in order to provide to said at least one hydrogen pump, in mechanical form via a transmission shaft connecting the turbine to said at least one hydrogen pump, at least part of the power necessary for the operation of said at least one hydrogen pump;
the system includes a circuit for bypassing the turbine, provided with a valve which connects an upstream point located between said at least one combustion device and the turbine and a downstream point located downstream of the turbine, the valve being configured to control the passage of the flow of fuel produced by said at least one combustion device into the turbine and/or the turbine bypass circuit;
said at least one hydrogen pump and the turbine together form a turbopump;
the system comprises a flow separator disposed upstream of said at least one combustion device in the direction of circulation of the hydrogen from said at least one hydrogen pump and which is configured to separate the hydrogen into a first flow provided to said at least one combustion device and a second flow which joins the fuel produced by said at least one combustion device downstream of the latter;
said at least one hydrogen pump is an electrically-powered pump and the system comprises at least one electric motor configured to provide to the electrically-powered pump all of the power necessary for the operation of the electrically-powered pump;
the air supply circuit is configured to transport air taken from a hydrogen engine to said at least one combustion device and comprises a pressure relief device configured to ensure a rise in the pressure of this air with a view to introducing it into said at least one combustion device;
the system comprises a compression device configured to increase the pressure of the fuel produced by said at least one combustion device;
the compression device is disposed in the fuel circuit downstream of the heat exchanger(s) which are fluidly connected between the fuel circuit, downstream of said at least one combustion device, and the hydrogen circuit, downstream of said at least one hydrogen pump.

Another embodiment relates to an air, sea or land locomotion machine, characterized in that it comprises an aerobic hydrogen engine and a conditioning system as briefly explained above for the fuel conditioning of an aerobic hydrogen engine.

Another embodiment relates to a system for supplying fuel to a combustion chamber of an aerobic hydrogen engine, characterized in that the fuel supply system comprises:
at least one fuel conditioning system as briefly explained above,
at least one liquid hydrogen tank configured to deliver liquid hydrogen to said at least one hydrogen pump of said at least one fuel conditioning system, and
an injection device configured to inject the fuel produced by said at least one combustion device of said at least one fuel conditioning system into a combustion chamber of an aerobic hydrogen engine.

According to one possible feature, the system comprises a pump, for example immersed in the tank, which is configured to deliver pressurized hydrogen.

Another embodiment relates to a fuel conditioning method for an aerobic hydrogen engine, characterized in that the method comprises:
a rise in the pressure of liquid hydrogen,
a rise in the temperature of the pressurized hydrogen,
a partial combustion of the hydrogen with air in order to produce a fuel comprising a gas mixture including gaseous hydrogen and which is devoid of oxygen.

According to other possible features:
the hydrogen temperature rise is obtained at least partly by cooling one or several fluid(s);
the hydrogen temperature rise is obtained at least partly by cooling the fuel resulting from the partial combustion;
the method comprises a partial expansion of the hydrogen to provide in mechanical form at least part of the power necessary for the rise in the liquid hydrogen pressure before the partial combustion of the hydrogen;
the method comprises a partial expansion of the fuel produced by the partial combustion of the hydrogen to provide in mechanical form at least part of the power necessary for the rise in the liquid hydrogen pressure before the partial combustion of the hydrogen;
at least part of the power necessary for the liquid hydrogen pressure rise is provided in electrical form;
the method comprises the separation of a hydrogen flow that has been subjected to a pressure and temperature rise into a first flow subjected to the partial combustion and a second flow which joins the fuel produced by the partial combustion before its injection into a combustion chamber of an engine;
the hydrogen that has been subjected to a pressure and temperature rise is directly subjected to the partial combustion;
the method comprises an increase in the pressure of the fuel produced by the partial combustion of the hydrogen with air;
the increase in the pressure of the fuel produced by the partial combustion of the hydrogen with air is carried out after the cooling of the fuel resulting from the partial combustion.

### BRIEF DESCRIPTION OF THE DRAWINGS

The object of the present disclosure and its advantages will be better understood upon reading the detailed description given below of different embodiments given as non-limiting examples. This description refers to the pages of appended figures, on which:

FIG. 1 represents a first possible architecture of a circuit of a fuel conditioning system SC1 integrated into a system 10 for supplying fuel to a combustion chamber of an aerobic hydrogen engine of an aircraft according to the invention;

FIG. 2 represents a second possible architecture of a circuit of a fuel conditioning system SC2 integrated into a system 110 for supplying fuel to a combustion chamber of an aerobic hydrogen engine of an aircraft according to the invention;

FIG. 3 represents a third possible architecture of a circuit of a fuel conditioning system SC3 integrated into a system 1110 for supplying fuel to a combustion chamber of an aerobic hydrogen engine of an aircraft according to the invention;

FIG. 4 represents a fourth possible architecture of a circuit of a fuel conditioning system SC4 integrated into a system 210 for supplying fuel to a combustion chamber of an aerobic hydrogen engine of an aircraft according to the invention;

FIG. 5 represents a flowchart illustrating the main steps of a fuel conditioning method for a combustion chamber of an aerobic hydrogen engine of an aircraft according to the invention in relation to each of the different architectures of FIGS. 1 to 4, and more generally, of a method for supplying fuel to this combustion chamber of the aerobic hydrogen engine.

### DESCRIPTION OF THE EMBODIMENTS

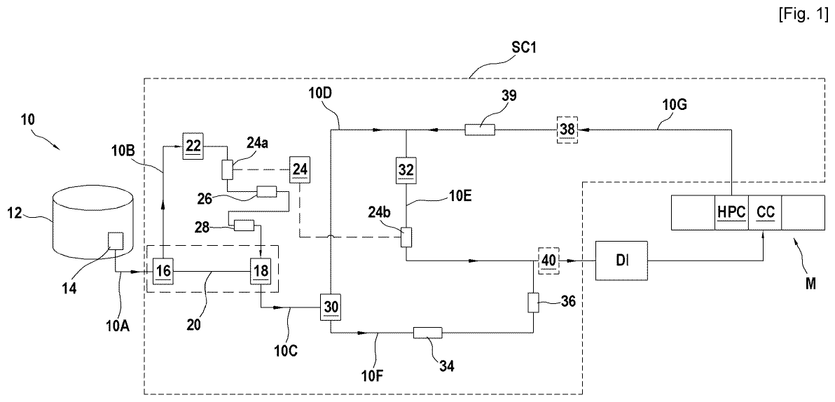

FIG. 1 represents a first possible architecture of a fuel conditioning system SC1 for an aerobic hydrogen engine M of an aircraft according to the invention (engine including at least one air inlet) or of a gas turbine of a hydrogen engine and, more particularly, for a combustion chamber CC of such an engine M.

The fuel conditioning system SC1 of FIG. 1 uses, as input, on the one hand, liquid hydrogen provided by one or several liquid hydrogen source(s) present on board the aircraft, here at least a liquid hydrogen tank 12 (several tanks may be present, in particular for the purposes of redundancy or distribution of the centers of mass in the aircraft) and, on the other hand, air provided by at least one air source present on board the aircraft in order to produce fuel that will be provided, at the outlet of the system SC1, to a device DI for injecting fuel into the combustion chamber CC of the engine M, as will be described later.

As represented in FIG. 1, the fuel conditioning system SC1 forms here part of a more general fuel supply system 10 which comprises elements or components external to the conditioning system SC1, such as said at least one liquid hydrogen tank 12 and the fuel injection device DI described below.

Said at least one liquid hydrogen tank 12 (here only one tank is represented and described but this in no way excludes the presence of other tanks and the following description also applies to a fuel supply system comprising several tanks) contains liquid hydrogen at a low temperature and at a low-pressure, for example respectively of the order of 20 to 25K and of the order of 1 bar. It will be noted that the tank 12 is designed, in a known manner, to have sufficient thermal insulation in order to control, or even cancel, the phenomenon of vaporization of the liquid hydrogen contained in the tank (a phenomenon known under the term “boil-off”). The system described below with reference to FIG. 1 and in particular its components, as well as the other possible architectures of systems described below with reference to the following figures, do not exploit this phenomenon.

As represented in FIG. 1, a boost pump 14 can be immersed in the tank 12 and has the function of pressurizing the liquid hydrogen present in the tank, for example at a pressure of 4 bars, in order to deliver, at the outlet of the tank, pressurized liquid hydrogen.

The fuel conditioning system SC1 comprises, as input, at least one liquid hydrogen pump 16 which is connected to the tank by a circuit portion 10A. Said at least one liquid hydrogen pump 16 is disposed downstream of the tank 12 (the downstream direction being indicated in relation to the direction of circulation of the hydrogen in the circuit from the tank 12).

The pump 16 which is powered by the pressurized liquid hydrogen delivered at the outlet of the tank 12 and circulating in the circuit portion 10A has the function of increasing the pressure of the liquid hydrogen, gradually until a pressure comprised in a first range for example from 10 to 200 bars, more particularly in a second range for example from 10 to 120 bars, or even in a third range for example from 10 to 80 bars and for example from approximately 50 bars in one exemplary embodiment. The pressure differences depend on the needs of the combustion chamber of the aerobic hydrogen engine of an aircraft. The pump 16 is more particularly connected to a turbine 18 via a mechanical transmission shaft 20 and thus forms, together with the turbine, a turbopump. The fuel conditioning system SC1 includes at least one turbopump. It will be noted that the boost pump 14 is immersed in the tank 12 forming a cryogenic bath, which makes it possible to overcome the problems of net positive suction pressure at the inlet of the liquid hydrogen pump 16 (phenomenon which relates to the problem of cavitation), while meeting the temperature and pressure requirements at the inlet of this pump.

The circuit of the fuel conditioning system SC1 comprises, downstream of the hydrogen turbopump 16 (in the direction of circulation of the hydrogen in the circuit), a circuit portion 10B comprising a regulation valve 22 followed by one or several heat exchanger(s) which are configured to increase the temperature of the pressurized hydrogen delivered by the turbopump 16.

In the example illustrated in FIG. 1, the circuit portion 10B can comprise several successive heat exchangers, including a first heat exchanger 24 which uses a heat source available on board the aircraft to achieve a first hydrogen temperature rise. This first heat exchanger 24 here uses a heat source produced in another portion (10E) of the circuit of the conditioning system which will be described later and where, more particularly, hot combustion gases (fuel) are generated. In the architecture described here, the first heat exchanger 24 is configured to ensure the greatest hydrogen temperature rise compared to the other heat exchangers described below (auxiliary exchangers) and is therefore qualified as a main exchanger. The fuel conditioning system SC1 can comprise several exchangers of the exchanger 24 type.

The first heat exchanger 24 can be followed by a second heat exchanger 26 which achieves a second hydrogen temperature rise, here by cooling of a heat transfer fluid from another circuit present on board the aircraft, such as for example an oil circuit of the aircraft.

A third heat exchanger 28 which can be disposed downstream of the second exchanger 26 achieves a third hydrogen temperature rise, here by cooling of another heat transfer fluid from another circuit present on board the aircraft such as for example an air circuit, and more particularly a cabin air circuit coming from an environmental control system called ECS.

By heating the hydrogen in the circuit of the conditioning system SC1 in FIG. 1, other circuits present on board the aircraft are therefore cooled, which makes it possible to reduce energy needs and thus improve the energy balance of the aircraft by using the available enthalpies of the on-board circuits.

For example, the liquid hydrogen whose temperature is approximately 25K at the level of the regulation valve 22 increases in temperature at the outlet of the first exchanger 24 to a temperature of approximately 240K, then passes to a temperature of approximately 280K at the outlet of the second exchanger 26 and finally to a temperature of approximately 310K at the outlet of the third exchanger 28.

It will be noted that the desired temperature of the hydrogen at the outlet of the last exchanger is comprised for example between 240K and 310K.

For example, the thermal power exchanged in the main exchanger can be of the order of 1.3 MW, while it is rather close to 200 kW and 50 KW respectively in the two other exchangers. These last two exchangers having little impact on the circuit of the conditioning system, they are therefore easier to design and control than the main exchanger 24.

The order in which the heat exchangers of the circuit are configured can of course vary in particular depending on the temperature ranges required by each of the fluids used to heat the hydrogen.

Any heat exchanger which is configured to heat a fluid from a temperature of the order of 200K at the inlet to a temperature comprised between 240K and 310K at the outlet of this exchanger may be suitable, in addition to the temperature increase ensured by the first exchanger.

The number and type of exchangers, as well as the circuits of the aircraft (in particular the calorific fluid(s) used) from which the heat is extracted to heat the hydrogen can of course vary from the description that has just been made.

The circuit portion 10B is connected, downstream, to the turbine 18 of the hydrogen turbopump which thus receives the pressurized hydrogen, for example at a temperature of 310K and a pressure of 50 bars, derived from the exchanger 28.

The partial expansion of the pressurized hydrogen in the turbine 18 provides the turbopump with the power necessary for the remainder of the supply cycle. Particularly, mechanical power is thus transmitted to the hydrogen pump 16 via the mechanical transmission shaft 20 connecting the turbine 18 to the pump 16 for the operation of this pump.

The regulation valve 22 participates in adjusting the appropriate hydrogen flow rate injected into the turbine 18 and in achieving the optimal performances of this turbine. According to one variant of embodiment not represented, the regulation valve can be arranged in parallel with the turbine in order to form a device for bypassing the latter. This configuration is justified by reasons of ease of valve design, ease of regulation and instability at the low operating point of the pump.

The hydrogen at the outlet of the turbine 18 is for example at a pressure of the order of 30 bars and at a temperature of the order of 260K.

The circuit of the fuel conditioning system SC1 includes, downstream of the turbine 18, a circuit portion 10C connecting the latter to a flow separator 30.

The flow separator 30 is connected, via a circuit portion 10D, to at least one combustion device, also called pre-combustion chamber 32 (pre-burner), which produces combustion gases rich in hydrogen and devoid of oxygen, constituting more particularly a fuel for the combustion chamber CC of the aerobic engine M of the aircraft (e.g. gas turbine). For example, the molar composition of the gases at the outlet of the pre-combustion chamber 32 can be as follows: between 5 and 10% of N2, between 3 and 5% of H2O and between 85 and 92% of H2. For example, the pre-combustion chamber 32 can be a gas generator similar to the one used in the Ariane 6 launcher or a gas generator similar to that of the Vulcain engine. Generally, the components used in this system can be similar to components of a space engine such as those used in the system of the auxiliary power unit of the upper stage of the Ariane 6 launcher at appropriate sizing, in particular to replace the liquid oxygen with air and adapt it to the resulting thermomechanical characteristics. For example, the first heat exchanger 24 can be an exchanger of the system of the auxiliary power unit of the upper stage of the Ariane 6 launcher and which can be resized according to the thermal power requirements. The pump may be similar to a motor pump of the auxiliary power unit of the upper stage of the Ariane 6 launcher adapted for the flow rate and pressure requirements required by the present conditioning circuit.

The circuit of the fuel conditioning system SC1 includes, downstream of the pre-combustion chamber 32, the circuit portion 10E already mentioned above in relation to the main exchanger 24 and which connects the latter to the injection device DI of the combustion chamber CC of the aerobic engine.

The flow separator 30 is connected, by a circuit portion 10F, to the circuit portion 10E downstream of the pre-combustion chamber 32, in an area of this portion located downstream of the pre-combustion chamber and upstream of the injection device DI of the combustion chamber.

The flow separator is thus configured to separate the hydrogen delivered by the turbine 18, on the one hand, into a first flow provided to the pre-combustion chamber 32 by the circuit portion 10D and, on the other hand, into a second flow which joins the fuel produced by the pre-combustion chamber 32 upstream of the combustion injection device DI.

The flow rate ratio between the two flows can for example be of 50/50 or, depending on the needs of the equipment located downstream of the flow separator in the different circuit portions concerned, the ratio can adopt another distribution.

It will be noted that the circuit portion 10F (optional) comprises one or several successive heat exchangers of which only one 34 is represented. In the present example, the exchanger 34 can be configured to increase the temperature of the second hydrogen flow before it enters the combustion chamber of the engine. The nature of the heat exchanger(s) used in this circuit portion or branch is the same as that of the exchangers 26 and 28 of the circuit portion or branch 10B described above, namely they are for example configured to cool an oil circuit and/or an air circuit and/or a cabin air circuit (ECS) of the aircraft. In the present example, the exchanger 34 is an exchanger which is configured to cool the cabin air circuit of the aircraft. The circuit portion 10F can also comprise, downstream of the exchanger 34, an injector 36 located upstream of the connection point with the circuit portion 10E, a point which is located upstream of the injection device DI of the combustion chamber CC of the engine.

For example, the hydrogen at the outlet of the exchanger 34 can be at a temperature of the order of 280K and at a pressure of 4 bars.

The circuit of the fuel conditioning system SC1 also includes an air supply circuit which here takes the form of a circuit portion 10G. Generally, the circuit portion 10G provides the pre-combustion chamber 32 with air (coming from an air source available on board the aircraft and external to the fuel conditioning system SC1) at a pressure meeting the pressure requirements required at the inlet of the pre-combustion chamber 32 and which are for example of the order of 50 bars. The circuit portion 10G can further include a pressure relief device or booster 38 which is configured to ensure a rise in pressure of the air provided by the air source in case this air does not have the required pressure. The circuit portion 10G can also include an injector 39 making it possible to ensure combustion stability by control of the pressure and of the air intake flow rate. In the exemplary embodiment illustrated in FIG. 1, the circuit portion 10G connects the high-pressure compressor HPC of the hydrogen engine M of the aircraft to the pre-combustion chamber 32. This circuit portion 10G forms an air supply circuit to transport air taken from the hydrogen engine to the pre-combustion chamber 32. The circuit portion 10G can further comprise one or several heat exchanger(s) to cool, if necessary, the air taken from the engine. According to another embodiment not represented, the air source present on board the aircraft and which is capable of providing air to the pre-combustion chamber 32 can be a pressurized air cylinder or tank.

The first hydrogen flow provided through the circuit portion 10D by the flow separator 30 from the flow delivered by the turbine 18 is introduced into the pre-combustion chamber 32 where it is mixed with air coming from the air supply circuit 10G. It will be noted that the hydrogen present in the circuit upstream of the pre-combustion chamber 32, and in particular at the inlet of this pre-combustion chamber, is not necessarily in gaseous form. The hydrogen can be in a subcritical, therefore gaseous, state if its pressure is lower than the critical pressure (around 13 bars for the hydrogen) and in a supercritical state if its pressure is higher than the critical pressure. The hydrogen is partially burned in the pre-combustion chamber 32 (for example 4% by volume of the hydrogen can be burned) and the partial combustion is controlled (by a control device not represented) in order to consume all of the oxygen provided by the air supply. The partial combustion thus produces a gas mixture including gaseous hydrogen, nitrogen, water vapor and forming the fuel for the hydrogen engine of the aircraft, for example in the molar composition mentioned above. The absence of oxygen in the gas mixture (fuel) which will be provided to the combustion chamber of the engine provides great safety to the supply system thus configured.

It will be noted that the need to heat the hydrogen before entering the pre-combustion chamber 32 (via the upstream heat exchanger(s) 24, 26, 28) is necessary to avoid combustion instability problems of the hydrogen in the pre-chamber and avoid icing phenomena likely to occur in the pre-chamber with hydrogen at low temperature.

The pre-combustion chamber 32 is in particular present in order to increase the temperature of the hydrogen. For example, the gas mixture produced by the pre-combustion chamber 32 reaches a temperature of the order of 750K and a pressure of approximately 40 bars.

The circuit portion 10E located downstream of the pre-combustion chamber 32 is connected to the heat exchanger 24 described above and thus makes it possible to heat the hydrogen circulating in the circuit portion 10B described above upstream of the turbine 18. FIG. 1 represents the two parts of the exchanger 24a and 24b in each of which circulates one of the two fluids which are respectively the hydrogen to be heated and the mixture of hot combustion gases (fuel) to be cooled. This configuration makes it possible to pool the enthalpy requirements of the two circuit portions 10E and 10B. It will be noted indeed that the temperature of the hydrogen upstream of the turbine 18 must be increased and that the temperature of the combustion gases derived from the pre-combustion chamber 32 is too high to be able to be used directly in the combustion chamber of the engine.

For example, the temperature of the gas mixture produced by the pre-combustion chamber 32 and cooled in the exchanger 24 is comprised between 400K and 600K and is for example approximately 550K.

The second flow transported by the circuit portion 10F joins the circuit portion 10E downstream of the exchanger 24 in order to mix with the cooled gas mixture (fuel).

The gas mixture (fuel) transported by the circuit portion 10E and enriched by the input of the second flow is thus conveyed to the injection device DI of the combustion chamber CC of the aerobic engine in order to be injected into the latter in a known manner. This gas mixture is for example at a temperature of approximately 550K and at a pressure of approximately 40 bars.

It should however be noted that the flow separator 30 and the associated circuit portion 10F can be omitted in one variant of embodiment and thus the conditioning system only comprises a single circuit portion at the outlet of the turbine 18 for the supply of hydrogen to the downstream part of the system which comprises in particular the pre-combustion chamber 32. In such a variant, the combustion chamber CC is thus supplied only from a single circuit portion and a single gas mixture directly derived from the pre-combustion chamber 32.

The configuration of the fuel conditioning system SC1 which has just been described (including the aforementioned variant), and in particular of the fuel supply system 10 which integrates the system SC1, makes it possible to improve the energy performances of the aircraft engine compared to an open cycle configuration, while minimizing the fluid losses in the system. Here, the entire hydrogen flow rate is re-injected into the engine, unlike an open cycle where part of the fuel is used for other functions and is released into the atmosphere without contributing to the operation of the engine.

Although not represented in FIG. 1, several components or subsystems of the same type can be present in the system concerned such as, for example, the tank 12 of the fuel supply system 10 and, in the fuel conditioning system SC1: the turbopump 16, 18, the main exchanger 24 and the pre-combustion chamber 32. For example, the main exchanger 24 and the pre-combustion chamber 32 can be made in the form of a single component or block.

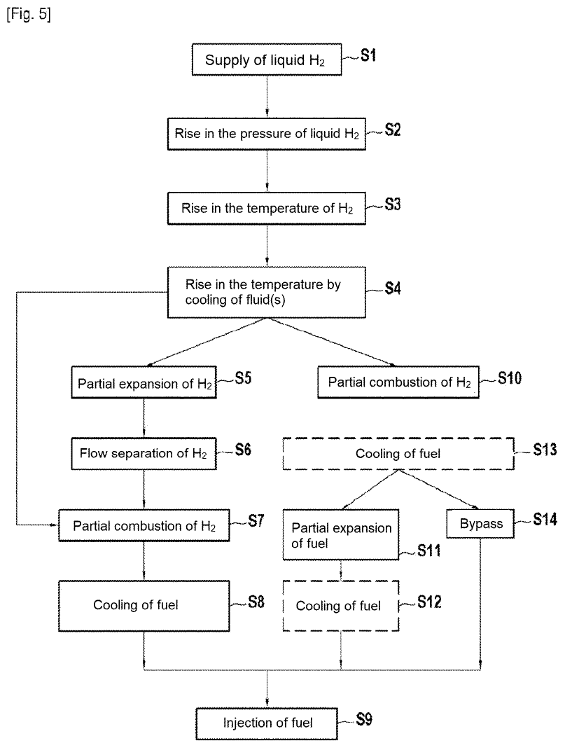

The of the aforementioned fuel conditioning system SC1 of FIG. 1 and the operation of the fuel supply system 10 of which it is part in this embodiment, are illustrated in FIG. 5 in the form of a flowchart describing the main steps of the method for conditioning fuel for the engine M and more generally of the method for supplying fuel for this engine.

More particularly, the method of FIG. 5 comprises the respective steps S1 to S4 of providing liquid hydrogen, increasing the pressure of liquid hydrogen and increasing the temperature of hydrogen, in particular by cooling a fluid (in this case the fuel coming from the pre-combustion chamber 32). This method then comprises a step S5 of partial expansion of the hydrogen whose pressure and temperature have been increased during the previous steps, then a step S6 (optional) of separating the flow resulting from the partial expansion of the previous step and a step S7 of partial combustion of the hydrogen with air in order to produce a fuel comprising a gas mixture including gaseous hydrogen and which is devoid of oxygen. During the next step S8, the fuel thus produced is cooled by heat exchange with the pressure of the hydrogen increased, as indicated above and which, for its part, is heated. The cooled fuel is then injected into the combustion chamber CC of the aerobic hydrogen engine M during a step S9. Steps S2-S8 are carried out by the fuel conditioning method for an aerobic hydrogen engine and steps S1 and S9 are only carried out by the method for supplying fuel to the aerobic hydrogen engine.

The circuit of the fuel conditioning system of FIG. 1 can also include, according to one variant of embodiment, a compression device 40, also called compressor, which is configured to increase the pressure of the fuel produced by the pre-chamber combustion 32. In this variant, the air booster 38 of the circuit portion 10G is omitted. The compressor 40 is disposed in the fuel circuit portion 10E located downstream of the heat exchanger(s) 24 (part 24b of the exchanger on the fuel circuit). This/these heat exchanger(s) is/are fluidly connected between the fuel circuit, downstream of the pre-combustion chamber 32 and the hydrogen circuit, downstream of the hydrogen pump 16. In the example represented in FIG. 1, the compressor 40 is positioned, in the circuit SC1, just upstream of the injection device DI and, more particularly, downstream of the connection point between the portion 10E and the optional portion 10F. The compressor 40 is thus disposed, here, at the outlet of the conditioning circuit SC1. However, the compressor 40 can, alternatively, be disposed upstream of this connection point. Of course, in the variant of embodiment described here, the circuit portion 10F can also be omitted. It will be noted that the compressor 40 can be a centrifugal compressor driven by an air turbine or a compressor driven by an electric motor.

By using a compressor 40 downstream of the pre-combustion chamber 32 and by removing the air booster 38 on the air circuit, the pressure at the inlet of the pre-combustion chamber 32 is decreased and therefore the pressure requirements on the hydrogen circuit and therefore the stresses associated therewith are reduced. Moreover, this variant makes it possible to simplify the design of the part 10G of the air supply circuit (in particular of the booster 38) in which the temperature of the air flow and its mass flow rate are restrictive in the embodiment where air is taken from the combustion chamber of the engine. The compressor 40 makes it possible to compensate for the pressure losses which occur upstream of the circuit and thus to provide the injection device 25 DI with fuel at an increased pressure, for example of the order of 50 bars. For example, the pressure at the inlet of the pre-combustion chamber 32 can be of the order of 50 bars, the pressure of the hydrogen at the outlet of the pump 16 can be of the order of 100 bars and 50 bars downstream of the turbine 18.

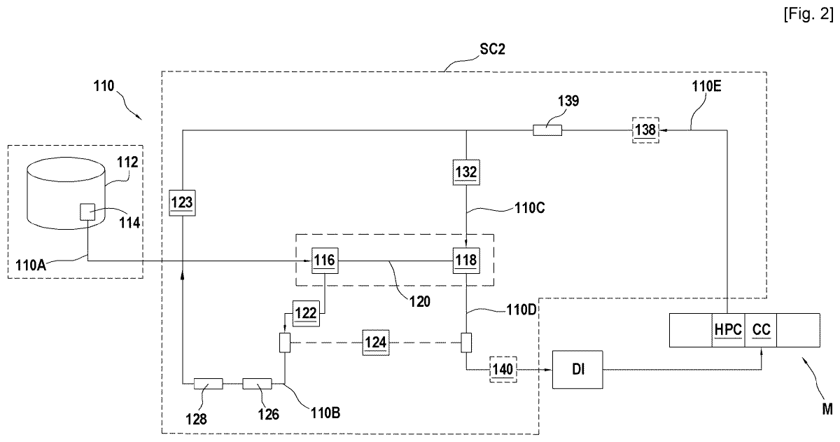

FIG. 2 represents a second possible architecture of a circuit of a fuel conditioning system SC2 for a combustion chamber CC of an aerobic hydrogen engine M of an aircraft according to the invention.

The fuel conditioning system SC2 of FIG. 2 uses, as input, on the one hand, liquid hydrogen provided by one or several liquid hydrogen source(s) present on board the aircraft, here at least a liquid hydrogen tank 112 (several tanks may be present) and, on the other hand, air provided by at least one air source present on board the aircraft in order to produce fuel which will be provided, at the outlet of the system SC2, to a device DI for injecting fuel into the combustion chamber CC of the engine M, as will be described later.

As represented in FIG. 2, the fuel conditioning system SC2 forms here part of a more general fuel supply system 110 which comprises elements or components external to the conditioning system SC2, such as said at least one liquid hydrogen tank 112 and the fuel injection device DI described below.

As for the first architecture of FIG. 1, the liquid hydrogen tank 112 in which a boost pump 114 can be immersed is configured to provide, at the outlet of the tank (and downstream of it in the direction of circulation of the hydrogen in the circuit from the tank) pressurized liquid hydrogen, via a circuit portion 110A, to a hydrogen pump 116 of the fuel conditioning system SC2 (inlet of the system SC2). The pump 116 is connected, via a mechanical transmission shaft 120, to a turbine 118 and forms together with the latter a turbopump. The fuel conditioning system SC2 also comprises, downstream of the pump 116 having been used to increase the pressure of the liquid hydrogen, a circuit portion 110B which includes a regulation valve 122 and, downstream of the latter, one or several heat exchanger(s) to ensure a rise in the temperature of the pressurized hydrogen. In this architecture, the system 110 can include the heat exchangers 124, 126 and 128 corresponding respectively to the heat exchangers 24, 26 and 28 of FIG. 1 (or at least the main exchanger 124).

The circuit portion 110B can also include, downstream of the heat exchanger(s), another regulation valve 123 which, like the regulation valve 122, also makes it possible to adjust the hydrogen flow rate in the circuit.

Unlike the architecture of FIG. 1, in the architecture of FIG. 2:
the circuit portion 10B which includes the heat exchanger(s) is not connected to the turbine 118 of the turbopump but to the pre-combustion chamber 132 and the hydrogen heated by this/these heat exchanger(s) is thus directly admitted in the pre-combustion chamber 132 to be burned partially therein thanks to air coming from the air supply circuit 110E identical to the circuit 10G of FIG. 1;
the mixture of combustion gases (fuel) generated by the pre-combustion chamber 132 (as for the architecture of FIG. 1, this mixture comprises partially burned gaseous hydrogen, nitrogen, water vapor and is free of oxygen; it can comprise the same molar composition as the one indicated above) is transported by a circuit portion 110C which directly connects the outlet of the pre-combustion chamber 132 to the inlet of the turbine 118 of the turbopump and is thus directly injected into this turbine where it undergoes partial expansion.

The fuel conditioning system SC2 includes, downstream of the turbine 118, a circuit portion 110D which connects the outlet of the turbine 118 to the injection device DI of the combustion chamber of the engine (the injection device DI forms, for its part, part of the fuel supply system 110).

As for the architecture of FIG. 1, the circuit portion 110D passes through the heat exchanger 124 (same configuration as for the circuit portion 10E with the heat exchanger 24 of FIG. 1) in which the mixture of combustion gases (fuel) derived from the pre-combustion chamber 132 is cooled, while the hydrogen circulating in the circuit portion 110B is heated.

It will be noted that the turbine 118 is a hot gas turbine which has operating and performance characteristics higher than those of the turbine 18 of the architecture of FIG. 1. The power delivered by the turbine 118 which operates with hot gases also makes it possible, as for the architecture of FIG. 1, to reduce the operating stresses of the hydrogen pump 116 (for example, a centrifugal pump) via the transmission shaft 120 connecting the turbine to the pump 116.

As long as the specifications of the components used in the circuit of FIG. 2 are less demanding than those of the components of the circuit FIG. 1 (hydrogen turbopump 16 and turbine 18) which must operate at low temperature, the performances of the system of FIG. 2 and the production cost of this system are improved compared to the system of FIG. 1.

Everything that has been described in relation to the architecture of FIG. 1 remains applicable to the architecture of FIG. 2 with the exception of the differences presented above.

The circuit in FIG. 2 comprises, downstream of the turbine 118, a single circuit connected to the injection device DI of the combustion chamber CC of the aerobic engine to supply this chamber with fuel. This arrangement simplifies the architecture of the system compared to an architecture where the flow derived from the turbine is separated into two flows by a flow separator, with a second circuit portion (analogous to the portion 10F of FIG. 1) which re-injects part of the flow downstream of the combustion gases derived from the pre-combustion chamber, after their passage through the main heat exchanger, in particular for their cooling.

However, according to one variant of embodiment not represented, the architecture of FIG. 2 can comprise a configuration with a flow separator as in FIG. 1.

For example, the temperatures of the hydrogen in the circuit portion 110B are respectively 180K, 210K and 250K at the outlet of the exchangers 124, 126 and 128. At the outlet of the pre-combustion chamber 132, the mixture of combustion gases (fuel) is for example at a temperature of the order of 630K and a pressure of 60 bars, which is a higher pressure than at the outlet of the pre-combustion chamber 32 in the FIG. 1. At the outlet of the turbine 118, the mixture of combustion gases which has been partially expanded, for example to a pressure of the order 50 bars, is cooled in the exchanger 124 for example to a temperature of the order of 470K.

Although not represented in FIG. 2, several components or subsystems of the same type may be present in the system concerned such as, for example, the tank 112 of the fuel supply system 110 and, in the fuel conditioning system SC2: the turbopump 116, 118, the main exchanger 124 and the pre-combustion chamber 132.

The operation of the aforementioned fuel conditioning system SC2 of FIG. 2 and the operation of the fuel supply system 110 of which it is part in this embodiment, is illustrated in FIG. 5 in the form of a flowchart describing the main steps of the method for conditioning fuel for the engine M and, more generally, of the method for supplying fuel for this engine.

More particularly, the method of FIG. 5 comprises the respective steps S1 to S4 of providing liquid hydrogen, increasing the pressure of liquid hydrogen and increasing the temperature of hydrogen, in particular by cooling a fluid (in this case the fuel coming from the pre-combustion chamber 132). This method then comprises a step S10 of partial combustion of the hydrogen with air in order to produce a fuel comprising a gas mixture including gaseous hydrogen and which is devoid of oxygen, then a step S11 of partial expansion of the fuel thus produced. During the following step S12, the fuel thus produced is cooled by heat exchange with the pressure of the hydrogen increased, as indicated above, and which, for its part, is heated. The cooled fuel is then injected into the combustion chamber CC of the aerobic hydrogen engine M during a step S9. Steps S2-S4, S10-S12 are carried out by the fuel conditioning method for an aerobic hydrogen engine. Steps S1 and S9 are only carried out by the method for supplying fuel to the aerobic hydrogen engine.

The circuit of the fuel conditioning system of FIG. 2 can also include, according to one variant of embodiment, a compressor 140 which is configured to increase the pressure of the fuel produced by the pre-combustion chamber 132. In this variant, the air booster 138 of the circuit portion 110E is omitted. The compressor 140 is disposed in the fuel circuit portion 110D located downstream of the heat exchanger(s) 124. This heat exchanger(s) are fluidly connected between the fuel circuit, downstream of the pre-combustion chamber 132 and the hydrogen circuit, downstream of the hydrogen pump 116. In the example represented in FIG. 2, the compressor 140 is positioned, in the circuit SC2, between the heat exchanger(s) 124 and the injection device DI that is to say at the outlet of the conditioning circuit SC2.

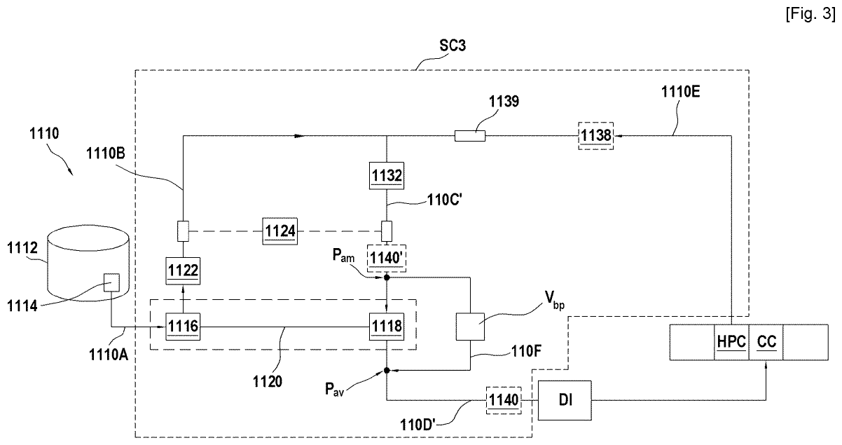

FIG. 3 represents a third possible architecture of a circuit of a fuel conditioning system SC3 for a combustion chamber CC of an aerobic hydrogen engine M of an aircraft according to the invention.

The architecture of FIG. 3 is very similar to that of FIG. 2 and the corresponding elements of FIG. 2 which are included in FIG. 3 are preceded by the number “1” in the latter.

As represented in FIG. 3, the fuel conditioning system SC3 is here part of a more general fuel supply system 1110 which comprises elements or components external to the conditioning system SC3, such as said at least one liquid hydrogen tank 1112 and the fuel injection device DI.

The architecture of the system in FIG. 3 differs from that in FIG. 2, mainly by the fact that:
the heat exchanger 1124 which at least partly ensures the heating of the hydrogen circulating in the circuit portion 1110B is placed directly at the outlet of the pre-combustion chamber 1132 on the circuit portion 110C′ connecting the pre-combustion chamber to the turbine 1118 and not downstream of the turbine (as in FIG. 2 where the exchanger is placed downstream of the turbine 118).
a circuit portion 110F for bypassing the turbine 1118 is arranged between an upstream point Pam located on the circuit portion 110C′, upstream of the turbine and downstream of the exchanger 1124, and a downstream point Pav located on the circuit portion 110D′ which connects the turbine to the injection device DI. This circuit portion 110F is equipped with a bypass-type regulation valve Vbp which is configured to control the passage of the flow of the mixture of combustion gases (fuel) in the turbine 1118 and/or in the circuit portion 110F. When the regulation valve is completely open, the flow circulating in the circuit portion 110C′ flows completely into the bypass circuit portion 110F, thus stopping the operation of the turbine. The regulation valve Vbp is thus servo-controlled by the thrust regime of the aircraft.

It will be noted that unlike the architecture of FIG. 2, the circuit portion 1110B includes a single heat exchanger 1124 corresponding to the exchanger 124 of FIG. 2 and not several heat exchangers. However, according to one variant not represented, exchangers analogous to the other exchangers 126 and 128 of FIG. 2 can be added.

In one variant of embodiment not represented, the heat exchanger 1124 can be placed after the downstream point Pav of the bypass circuit portion 110F on the circuit portion 110D′, that is to say downstream of the turbine as in the architecture of FIG. 2.

Although not represented in FIG. 3, several components or subsystems of the same type may be present in the system concerned such as, for example, the tank 1112 of the fuel supply system 1110 and, in the fuel conditioning system SC3: the turbopump 1116, 1118, the main exchanger 1124 and the pre-combustion chamber 1132.

The operation of the aforementioned fuel conditioning system SC3 of FIG. 3 and the operation of the fuel supply system 1110 of which it is part in this embodiment, is illustrated in FIG. 5 in the form of a flowchart describing the main steps of the method for conditioning fuel for the engine M and, more generally, of the method for supplying fuel to this engine.

More particularly, the method of FIG. 5 comprises the respective steps S1 to S4 of providing liquid hydrogen, increasing the pressure of liquid hydrogen and increasing the temperature of hydrogen, in particular by cooling a fluid (in this case the fuel coming from the pre-combustion chamber 1132). This method then comprises a step S10 of partial combustion of the hydrogen with air in order to produce a fuel comprising a gas mixture including gaseous hydrogen and which is devoid of oxygen. During the next step S13, the fuel thus produced is cooled by heat exchange with the pressure of the hydrogen increased, as indicated above, and which, for its part, is heated. The method then includes either a step S11 of partial expansion of the fuel thus produced and cooled, or a bypass step S14 avoiding the partial expansion step. The cooled fuel, partially expanded or not, is then injected into the combustion chamber CC of the aerobic hydrogen engine M during a step S9. Steps S2-S4, S10, S13, S11, S14 are carried out by the fuel conditioning method for an aerobic hydrogen engine. Steps S1 and S9 are only carried out by the method for supplying fuel to the aerobic hydrogen engine.

The circuit of the fuel conditioning system of FIG. 3 can also include, according to one variant of embodiment, a compressor 1140 which is configured to increase the pressure of the fuel produced by the pre-combustion chamber 1132. In this variant, the air booster 1138 of the circuit portion 1110E is omitted. The compressor 1140 can be disposed in the fuel circuit portion 110D′ located downstream of the heat exchanger(s) 1124. This/these heat exchanger(s) is/are fluidly connected between the fuel circuit, downstream of the combustion pre-chamber 1132 and the hydrogen circuit, downstream of the hydrogen pump 1116. In the example represented in FIG. 3, the compressor 1140 is positioned, in the circuit SC3, between the heat exchanger(s) 1124 and the injection device DI that is to say at the outlet of the conditioning circuit SC3. More particularly, the compressor 1140 is disposed downstream of the turbine 1118 and of the point Pav of the bypass portion 110F.

According to another variant of embodiment illustrated in FIG. 3, the compressor 1140′ is positioned downstream of the exchanger(s) 1124, in the portion 110C′ and upstream of the point Pam of the bypass portion 110F and therefore upstream of the turbine 1138. The same characteristics and advantages as those of the previous variant of the compressor 1140 also apply here and will not be repeated.

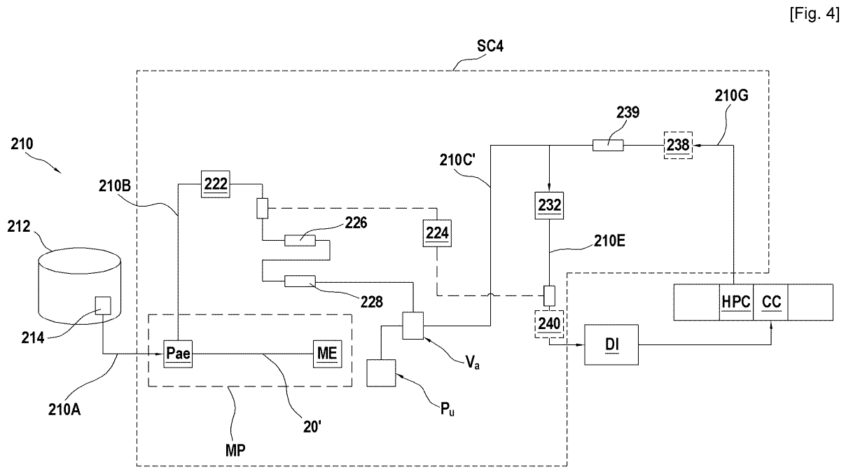

FIG. 4 represents a fourth possible architecture of a circuit of a fuel conditioning system SC4 for a combustion chamber CC of an aerobic hydrogen engine M of an aircraft according to the invention.

The architecture of FIG. 4 is similar in terms of cycle and supply circuit to that of FIG. 1 and the corresponding elements of FIG. 1 which are included in FIG. 4 are preceded by the number “2” in the latter.

As represented in FIG. 4, the fuel conditioning system SC4 is here part of a more general fuel supply system 210 which comprises elements or components external to the conditioning system SC4, such as said at least one liquid hydrogen tank 212 and the fuel injection device DI.

Unlike the architecture of FIG. 1, the fuel conditioning system SC4 of FIG. 4 comprises a motor pump MP which includes an electrically-powered, for example centrifugal, pump Pae replacing the pump 16 of FIG. 1 and an electric motor ME replacing the turbine 18 of FIG. 1. The electric motor is configured to provide the pump Pae with the power necessary for the operation of the latter and is in particular connected to it via a mechanical transmission shaft 20′. This arrangement makes it possible to overcome the requirements of design of the turbine 18 in FIG. 1.

As for the architecture of FIG. 1, the fuel conditioning system SC4 of FIG. 4 is also configured to ensure a rise in the temperature of the hydrogen at the outlet of the pump Pae via one or several heat exchanger(s) 224, 226 and 228, to produce a mixture of combustion gases (fuel) by using a gas generator 232 and to carry out a heat exchange between these hot gases (in order to cool them) and the hydrogen (to allow increasing the temperature of the hydrogen) via the heat exchanger(s) 224-228.

Unlike the architecture of FIG. 1, the hydrogen heated in the circuit portion 210B is directly injected into the pre-combustion chamber 232, via a circuit portion 210C′, instead of being provided to a turbine as in the architecture of FIG. 1.

A system Pu for purging the circuit is for example provided immediately downstream of the exchanger 228 thanks to a stop valve Va.

The use of an electric motor ME mechanically coupled to a hydrogen pump (motor pump), here a centrifugal pump, makes it possible to reduce the pressure at the outlet of the pump and therefore to reduce the mechanical stresses to which the hydrogen circuit is subjected as a whole. This arrangement also makes it easier to implement the pump.

Although not represented in FIG. 4, several components or subsystems of the same type may be present in the system concerned such as, for example, the tank 212 of the fuel supply system 210 and, in the fuel conditioning system SC4: the pump Pae and the engine ME, the main exchanger 224 and the pre-combustion chamber 232.

The operation of the aforementioned fuel conditioning system SC4 of FIG. 4 and the operation of the fuel supply system 210 of which it is part in this embodiment, is illustrated in FIG. 5 in the form of a flowchart describing the main steps of the method for conditioning fuel for the engine M and, more generally, of the method for supplying fuel for this engine.

More particularly, the method of FIG. 5 comprises the respective steps S1 to S4 of providing liquid hydrogen, increasing the pressure of liquid hydrogen and increasing the temperature of hydrogen, in particular by cooling a fluid (in this case the fuel coming from the pre-combustion chamber 232). This method then comprises a step S7 of partial combustion of the hydrogen with air in order to produce a fuel comprising a gas mixture including gaseous hydrogen and which is devoid of oxygen. During the next step S8, the fuel thus produced is cooled by heat exchange with the pressure of the hydrogen increased, as indicated above and which, for its part, is heated. The fuel thus cooled is then injected into the combustion chamber CC of the aerobic hydrogen engine M during a step S9. Steps S2-S4, S7, S8 are carried out by the fuel conditioning method for an aerobic hydrogen engine. Steps S1 and S9 are only carried out by the method for supplying fuel to the aerobic hydrogen engine.

The circuit of the fuel conditioning system of FIG. 4 can also include, according to one variant of embodiment, a compressor 240 which is configured to increase the pressure of the fuel produced by the pre-combustion chamber 232. In this variant, the air booster 238 of the circuit portion 210G is omitted. The compressor 240 is disposed in the fuel circuit portion 210E located downstream of the heat exchanger(s) 224. This/these heat exchanger(s) is/are fluidly connected between the fuel circuit, downstream of the pre-combustion chamber 232, and the hydrogen circuit, downstream of the hydrogen pump Pae. In the example represented in FIG. 4, the compressor 240 is positioned, in the circuit SC3, between the heat exchanger(s) 224 and the injection device DI that is to say at the outlet of the conditioning circuit SC3.

The different architectures described above have in particular the common point of restricting/confining the cryogenic part of the circuit as close as possible to the hydrogen tank, which makes it possible to prevent the engine from being in immediate contact with a cryogenic environment.

The risks of hydrogen leaks in the exchangers, in particular in the main exchanger 24 in FIG. 1, are reduced to the extent that the hydrogen could, in case of leak, at worst end up in the presence of the gas mixture (fuel) rich in hydrogen and free of oxygen, thus avoiding the risk of fire or explosion. The simplification of the architecture and therefore of its implementation is an advantage that comes from the limitation of the aforementioned risk.

The conditioning systems described above (SC1 to SC4) do not use the capacities of the combustion chamber of the aerobic engine to increase the temperature and pressure of the hydrogen and, in particular, do not take hot gases from this chamber for this purpose, thus avoiding a reduction in the performances of the propulsion system of the aircraft engine.

The conditioning systems described above (SC1 to SC4) are designed autonomously (i.e. without interaction) relative to the combustion chamber and to the engine subsystems, namely the HP (high-pressure) and LP (low-pressure) turbines of the engine.

The invention described above can also be applied to other engines such as train, boat or land locomotion machine engines or to fixed installations using gas turbines.

Although the present invention has been described with reference to specific embodiments, it is obvious that modifications and changes can be made to these examples without departing from the general scope of the invention as defined by the claims. Particularly, individual characteristics of the different illustrated/mentioned embodiments can be combined in additional embodiments. Consequently, the description and drawings should be considered in an illustrative rather than a restrictive sense.

It is also clear that all the characteristics described with reference to a system are transposable, alone or in combination, to one method and, conversely, all the characteristics described with reference to a method are transposable, alone or in combination, to one system.

1. A fuel conditioning system for an aerobic hydrogen engine wherein the system comprises:
at least one hydrogen pump configured to increase the liquid hydrogen pressure coming from a tank,
one or several heat exchanger(s) configured to increase the temperature of the pressurized hydrogen,
an air supply circuit,
at least one combustion device configured to ensure a partial combustion of the hydrogen with air coming from the air supply circuit in order to produce a fuel comprising a gas mixture including gaseous hydrogen and which is devoid of oxygen.

2. The system according to claim 1, wherein said at least one hydrogen pump is disposed upstream of the heat exchanger(s) in the direction of circulation of the hydrogen from said at least one hydrogen pump.

3. The system according to claim 1, wherein the heat exchanger(s) is/are configured to increase the hydrogen temperature at least partly by cooling one or several fluid(s).

4. The system according to claim 1, wherein it comprises a hydrogen circuit downstream of said at least one hydrogen pump in the direction of circulation of the hydrogen from said at least one hydrogen pump and a fuel circuit downstream of said at least one combustion device, the heat exchanger(s) being fluidly connected between the two circuits in order to increase the temperature of the hydrogen in the hydrogen circuit from the heat of the fuel produced by said at least one combustion device in the fuel circuit.

5. The system according to claim 1, wherein it comprises, downstream of said at least one hydrogen pump in the direction of circulation of the hydrogen from said at least one hydrogen pump, a turbine configured to ensure partial expansion of the pressurized hydrogen in order to provide to said at least one hydrogen pump, in mechanical form via a transmission shaft connecting the turbine to said at least one hydrogen pump, at least part of the power necessary for the operation of said at least one hydrogen pump.

6. The system according to claim 1, wherein the system comprises, downstream of said at least one combustion device in the direction of circulation of the fuel from said at least one combustion device, a turbine configured to ensure partial expansion of the fuel produced by said at least one combustion device in order to provide to said at least one hydrogen pump, in mechanical form via a transmission shaft connecting the turbine to said at least one hydrogen pump, at least part of the power necessary for the operation of said at least one hydrogen pump.

7. The system according to claim 6, wherein the system includes a circuit for bypassing the turbine, provided with a valve which connects an upstream point located between said at least one combustion device and the turbine and a downstream point located downstream of the turbine, the valve being configured to control the passage of the flow of fuel produced by said at least one combustion device into the turbine and/or the turbine bypass circuit.

8. The system according to claim 5, wherein said at least one hydrogen pump and the turbine together form a turbopump.

9. The system according to claim 1, wherein it comprises a flow separator disposed upstream of said at least one combustion device in the direction of circulation of the hydrogen from said at least one hydrogen pump and which is configured to separate the hydrogen into a first flow provided to said at least one combustion device and a second flow which joins the fuel produced by said at least one combustion device downstream of the latter.

10. The system according to claim 1, wherein said at least one hydrogen pump is an electrically-powered pump and the system comprises at least one electric motor configured to provide to the electrically-powered pump all of the power necessary for the operation of the electrically-powered pump.

11. The system according to claim 1, wherein the air supply circuit is configured to transport air taken from an aerobic hydrogen engine to said at least one combustion device and comprises a pressure relief device configured to ensure a rise in the pressure of this air with a view to introducing it into said at least one combustion device.

12. The system according to claim 1, wherein the system comprises a compression device configured to increase the pressure of the fuel produced by said at least one combustion device.

13. The system according to claim 12, wherein it comprises a hydrogen circuit downstream of said at least one hydrogen pump in the direction of circulation of the hydrogen from said at least one hydrogen pump and a fuel circuit downstream of said at least one combustion device, the heat exchanger(s) being fluidly connected between the two circuits in order to increase the temperature of the hydrogen in the hydrogen circuit from the heat of the fuel produced by said at least one combustion device in the fuel circuit, the compression device is being disposed in the fuel circuit downstream of the heat exchanger(s) which are fluidly connected between the fuel circuit, downstream of said at least one combustion device, and the hydrogen circuit, downstream of said at least one hydrogen pump.

14. A system for supplying fuel to a combustion chamber of an aerobic hydrogen engine, wherein the fuel supply system comprises:
at least one fuel conditioning system according to claim 1,
at least one liquid hydrogen tank configured to deliver liquid hydrogen to said at least one hydrogen pump of said at least one fuel conditioning system, and
an injection device configured to inject the fuel produced by said at least one combustion device of said at least one fuel conditioning system into a combustion chamber of an aerobic hydrogen engine.

15. The fuel supply system according to claim 14, wherein it comprises a pump which is configured to deliver pressurized hydrogen to said at least one fuel conditioning system.

16. A fuel conditioning method for an aerobic hydrogen engine, wherein the method comprises:
a rise in the pressure of liquid hydrogen,
a rise in the temperature of the pressurized hydrogen,
a partial combustion of the hydrogen with air in order to produce a fuel comprising a gas mixture including gaseous hydrogen and which is devoid of oxygen.

17. The method according to claim 16, wherein the hydrogen temperature rise is obtained at least partly by cooling one or several fluid(s).

18. The method according to claim 16, wherein the hydrogen temperature rise is obtained at least partly by cooling the fuel resulting from the partial combustion.

19. The method according to claim 16, wherein it comprises a partial expansion of the hydrogen to provide in mechanical form at least part of the power necessary for the rise in the liquid hydrogen pressure before the partial combustion of the hydrogen.

20. The method according to claim 16, wherein it comprises a partial expansion of the fuel produced by the partial combustion of hydrogen to provide in mechanical form at least part of the power necessary for the rise in the liquid hydrogen pressure before the partial combustion of the hydrogen.

21. The method according to claim 16, wherein at least part of the power necessary for the liquid hydrogen pressure rise is provided in electrical form.

22. The method according to claim 16, wherein it comprises the separation of a hydrogen flow that has been subjected to a pressure and temperature rise into a first flow subjected to the partial combustion and a second flow which joins the fuel produced by the partial combustion before its injection into a combustion chamber of an engine.

23. The method according to claim 16, wherein the hydrogen that has been subjected to a pressure and temperature rise is directly subjected to the partial combustion.

24. The method according to claim 16, wherein it comprises an increase in the pressure of the fuel produced by the partial combustion of the hydrogen with air.

25. The method according to claim 24, wherein the hydrogen temperature rise is obtained at least partly by cooling the fuel resulting from the partial combustion and the increase in the pressure of the fuel produced by the partial combustion of the hydrogen with air is carried out after the cooling of the fuel resulting from the partial combustion.
